(19) United States
(12) Patent Application Publication
(10) Pub. No.: US 2025/0226491 A1
(43) Pub. Date: Jul. 10, 2025

(54) ACCUMULATOR CELL HOUSING AND BATTERY OR BATTERY MODULE FORMED FROM MULTIPLE SECONDARY CELLS ON THE BASIS OF A UNIFORM ACCUMULATOR CELL HOUSING DESIGN

(71) Applicant: SFT - Consulting, Inhaber Volker Seefeldt, Marsberg (DE)

(72) Inventor: Volker Seefeldt, Marsberg (DE)

(21) Appl. No.: 18/853,823

(22) PCT Filed: Mar. 21, 2023
(86) PCT No.: PCT/EP2023/057157

§ 371 Date: Oct. 3, 2024

(30) Foreign Application Priority Data
Apr. 12, 2022 (DE) 10 2022 108 694.9

(51) Int. Cl. H01M 50/107; H01M 50/152; H01M 50/258; H01M 50/342; H01M 50/507

(52) U.S. Cl. CPC H01M 50/107; H01M 50/152; H01M 50/258; H01M 50/3425; H01M 50/507; H01M 2200/20

(57) ABSTRACT

The invention relates to an accumulator cell housing and a battery or a battery cell module formed from multiple secondary cells on the basis of a uniform accumulator cell housing design. Here, the starting point is a beaker-like structure with a beaker base, a beaker wall (1) and a beaker closure (3) opposite the beaker base. The chemical-physical means necessary for storing electrical energy can be introduced in the beaker cavity. Electrical connections are furthermore provided at least in the region of the beaker closure. Both in or on the beaker base and in or on the beaker closure there is provided a crenellation or crown structure which in each case has multiple spaced-apart protrusions (5, 6). A sandwich structure formation for creating a battery module is produced via a connection of base and cover plates (9, 10) with use of the previously mentioned protrusions of the respective crenellation or crown structures, and, in this regard, besides the improved mechanical stability, an optimised, symmetrical or uniform heat dissipation is possible.

The invention relates to an accumulator cell housing, consisting of a beaker-like structure with a beaker base, a beaker wall and a beaker closure opposite the beaker base, wherein the chemical-physical means required for storing electrical energy can be introduced into the beaker cavity, and with electrical connections at least in the region of the beaker closure according to claim 1, as well as a battery or a battery module comprising a plurality of secondary cells on the basis of a uniform accumulator cell housing design according to claim 8.

DE 10 2013 216 076 A1 discloses a battery system in which the cell housing of a battery cell is designed in such a way that the housing is deformed when the pressure rises, wherein the deformation can be detected by a detection device. In addition, so-called bursting elements are provided.

In the battery module according to DE 11 2015 001 861 T5, there are several cells, wherein a compact structure is created by surrounding a base plate with a flat frame and connecting the individual elements to each other with a material bond.

DE 10 2018 204 420 A1 discloses the idea of realizing a battery arrangement in such a way that load-bearing, structural integration into a vehicle, in particular an aircraft or spacecraft, is possible.

WO 2016/165834 A1 discloses a battery module with spring contact elements for connecting the poles and intermediate pole plates. Specifically, a round cell row formation or a round cell stack is used. In this publication, round cells refer to the formation of cylindrical cells.

In view of increasing electromobility, the accumulator cells required for this and the battery modules formed from them are becoming increasingly important.

It is well known that powerful battery modules have a far from inconsiderable mass, which accounts for a large proportion of the total weight of a vehicle. Therefore, the idea of integrating mechanically compact battery cell modules into the body of a vehicle in a load-bearing and mechanically stabilizing manner is obvious, wherein the conditions of accident protection and technical safety must of course be guaranteed and fulfilled.

If this idea of integrating battery modules is followed, the individual cells and cell housings, as well as the other necessary elements that form a sandwich structure, must be designed as mechanically stable and electrically safe as possible. The dead weight of the corresponding modules must also be taken into account.

Based on the prior art described in the introduction, it is therefore the object of the invention to specify a further developed accumulator cell housing which can be used in an advantageous manner as part of a battery or a battery module, in particular with regard to the aforementioned sandwich structure.

It is a sub-object of the invention to design the relevant cell housing in such a way that the necessary internal connection of the individual cells can be realized as space-savingly and safely as possible via so-called busbars. These electrical connections should be able to be arranged in a protected manner from cell to cell and at the same time be subject to guidance even under mechanical or other loads in order to avoid failures and, in particular, short circuits.

The connection of the individual cell housings to each other to form a battery module should be particularly simple from the point of view of subsequent recycling and should be created using technical means that require little effort to dismantle.

The object of the invention is solved by an accumulator cell housing according to the combination of features according to claim 1 and by a battery or a battery module comprising a plurality of secondary cells on the basis of a uniform accumulator cell housing design according to the combination of features according to claim 8, wherein the subclaims represent at least expedient designs and further developments.

Accordingly, an accumulator cell housing is assumed, consisting of a beaker-like structure with a beaker base, a beaker wall and a beaker closure opposite the beaker base.

All chemical-physical means required to store electrical energy can be introduced into the beaker cavity. Furthermore, electrical connections are available at least in the region of the beaker closure.

The beaker-like structure can preferably be designed as a hollow-cylindrical structure with a fixed beaker base, wherein, for example, aluminum or an aluminum alloy is used as the material and the beaker-like structure is manufactured using the extrusion process. This process is the preferred method for manufacturing the claimed accumulator cell housing.

Starting from the beaker base in the axial direction and distributed circumferentially in relation to the beaker wall, a plurality of spaced protrusions are formed according to the invention, which represent a crenellation or crown structure or resemble such a structure.

There are at least two crenellations with a space between them in the sense of an open space.

Furthermore, a comparable crenellation or crown structure is present in the region of the beaker closure, wherein this is realized either by an extension of sections of the beaker wall beyond the plane of the beaker closure or by a plurality of spaced protrusions which extend from the beaker closure on the height side over an electrical connection located there. In other words, the crenellations or crowns of the corresponding structure always protrude beyond a predetermined dimension of the plane of the beaker base and/or the beaker closure or beaker lid in the axial direction.

In a further development of the invention, the base of the beaker can be subject to deformation when the pressure is increased in the closed state of the beaker-like structure, which can be detected by a sensor arrangement. In the simplest case, the deflection interrupts the beam of a light barrier, contacts a switching device or activates a capacitive sensor or similar device.

In particular, the base of the beaker can also have a predetermined breaking point or be designed as a burst pressure diaphragm.

The formation of the crenellation or crown structure in the region of the beaker base provides sufficient free space for deformation of the beaker base, i.e. there is no possible restriction of the deformation path with all the disadvantageous consequences, particularly in the event of thermal overloading of a corresponding secondary cell.

The crenellation or crown structure on the beaker base side and that in the region of the beaker closure can be of the same design, but can also be different. This is particularly true with regard to the distances between two neighboring crenellations in the beaker closure. The distances can be adapted to the electrical connection conditions and the necessary busbars for the electrical secondary cell connection.

According to the invention, the crenellation or crown structure is designed as a complementary element to a mechanical connecting means in the construction of a battery cell module.

A connecting means is designed here, for example, as a clip, in particular as a plastic injection-molded part, and snaps into the respective crenellation wall sections via the gaps between the adjacent crenellations. A number of cell housings joined together to form a group thus form a mechanically connected battery module. The connecting means can be used both on the respective beaker base and beaker closure, i.e. also on both sides, so that a stable bond is created.

A recess or a setback section in the clip is used to accommodate and guide busbars for electrical contacting and connecting neighboring secondary cells.

It is advantageous if the clips and the busbars held and guided by the clip are located below the upper edge of the crenellation or crown structure in order to ensure the necessary electrical separation distances even if the corresponding battery module is joined with conductive base and/or cover plates to form a sandwich structure.

The respective mechanical connecting means can consist of an insulating material as described or have an electrically insulated section, particularly in the region in which a respective busbar is guided.

According to the invention, a battery or a battery cell module is provided which comprises a plurality of secondary cells which can be traced back to the uniform accumulator cell housing structure presented.

The large number of accumulator cell housings are arranged between a base plate and a cover plate, forming a stable, load-bearing sandwich structure.

The necessary components for a battery and/or thermal management system can be integrated or structurally arranged in the sandwich composite.

The respective base and cover plates can be connected to the cell housings with a material bond.

The design of the crenellation or crown structure provides a very good thermal connection to a thermal management system. A particular advantage is the symmetrical heat dissipation at both opposite ends of the cells.

The use of adhesive materials for a materially bonded connection, which include ceramic or mineral filler components, results in very good thermal bonding of the corresponding cell housings to the respective plate.

The base plate and/or cover plate can also be designed as a heat sink and, for example, have channels through which a fluid can be fed to allow the battery module to be temperature-controlled. In addition to active cooling of the module, heating is also possible in order to adjust the module to a favorable operating temperature.

The invention will be explained in more detail below with reference to an exemplary embodiment and with the aid of figures, wherein:

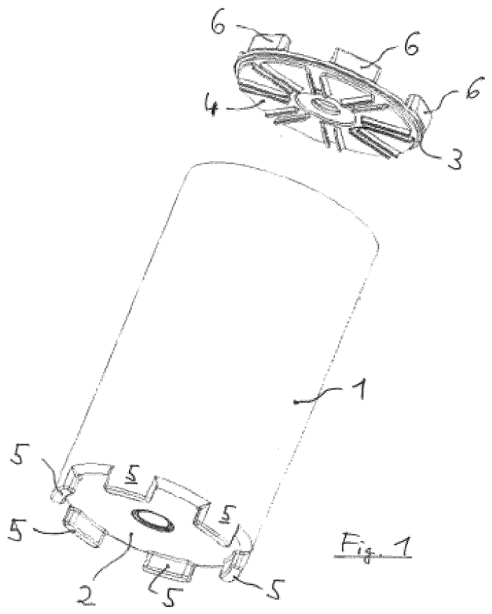

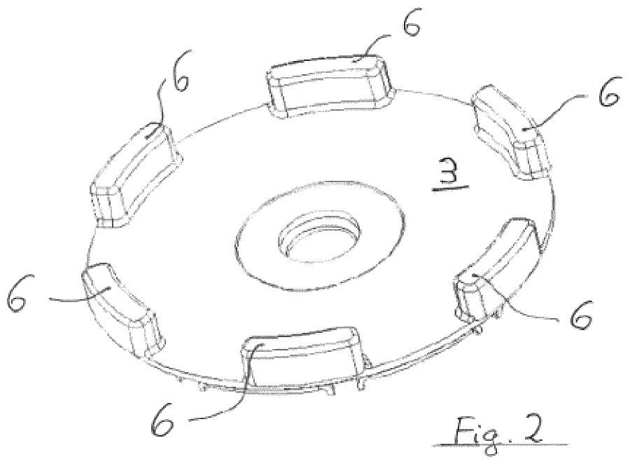

FIG. 1 shows a perspective view of an accumulator cell housing according to the invention with a beaker, having an integral beaker base and a beaker closure in the form of a beaker lid, but not yet connected to the actual beaker and a recognizable crenellation or crown structure in the region of the beaker base and on the beaker closure;

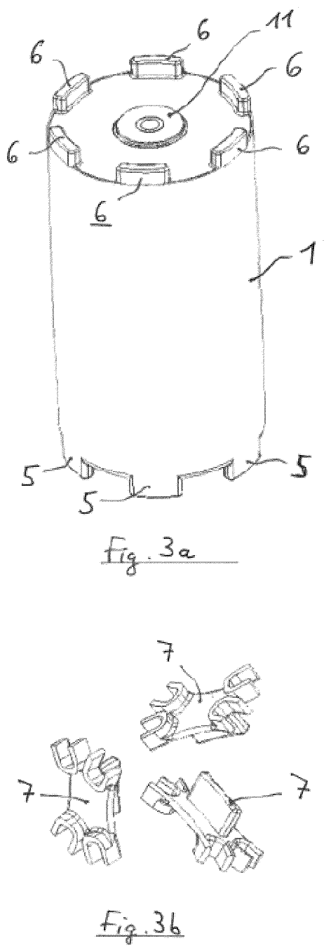

FIG. 2 shows a perspective view of an exemplary beaker cover, which has a crenellation or crown structure characterized by a plurality of spaced protrusions, and with a central recess for receiving an electrical connection pole of the respective secondary cell;

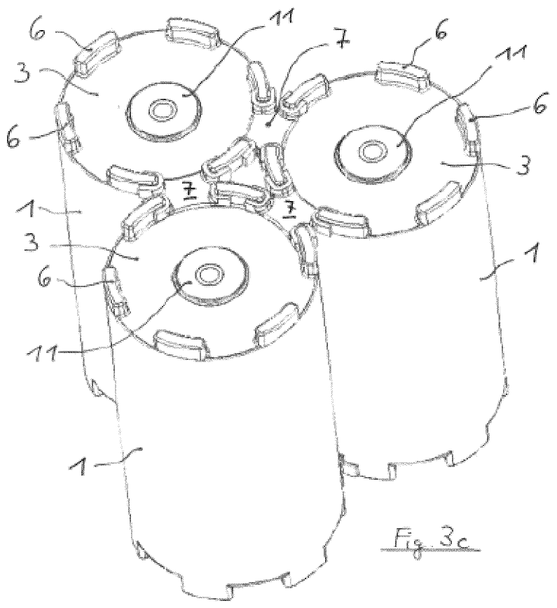

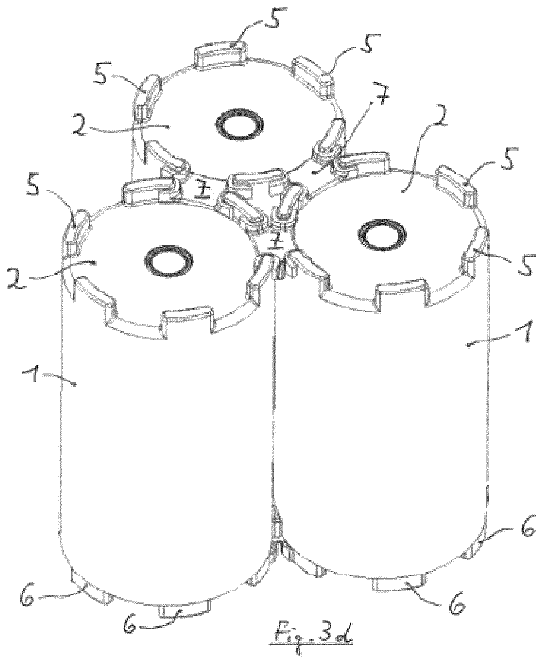

FIGS. 3a-d show a representation of configured accumulator cell housings, which are mechanically connected to form a three-battery module with the aid of connecting means in the form of clips (FIG. 3b), wherein the clips are used as connecting means both in the region of the crenellation or crown structure on the beaker closure (FIG. 3c) and also in the region of the beaker base (FIG. 3b);

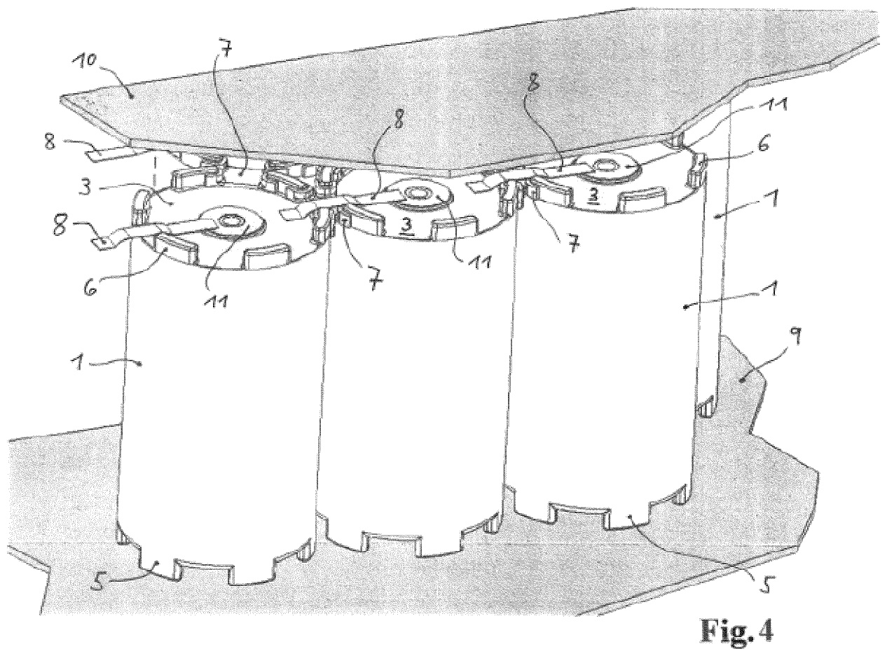

FIG. 4 shows a partially broken-away representation of a battery module with an indicated base and cover plate of a sandwich structure, mechanical connecting means and busbar connections, guided by the mechanical connecting means to create an electrical connection between the respective poles of the corresponding secondary cells.

The accumulator cell housings according to the exemplary embodiment and the figures are exemplarily realized as hollow-cylindrical structures in the form of a beaker.

The corresponding beaker has a beaker wall 1, a beaker base 2 and a beaker closure 3 opposite the beaker base 2, for example in the form of a beaker lid.

The necessary chemical-physical means for storing electrical energy (not shown in the figures) can be introduced into the beaker cavity. Electrical connecting means 4 are formed at least in the region of the beaker closure 3 and lead to a connection pole 9 (see FIGS. 3a and 3c).

Starting from the beaker base 2 in the axial direction and distributed circumferentially in relation to the beaker wall 1, a large number of spaced protrusions 5 are formed, which represent a crenellation or crown structure, as can be clearly seen in particular in FIGS. 1 and 2.

A comparable crenellation or crown structure with protrusions 6 (see for example FIG. 2) is present in the region of the beaker closure 3.

This crenellation or crown structure can be realized either by an extension of sections of the beaker wall 1 beyond the plane of the beaker closure 3 or by a plurality of spaced protrusions 6, which extend from the beaker closure 3 beyond an electrical connection pole located there.

The beaker base 2 can be subject to deformation when the pressure inside the beaker-like structure increases. This deformation can be detected by a sensor arrangement located in the region of the beaker base 2.

With regard to the crenellation or crown structure with the protrusions 5, a free space has been created that does not hinder the deformation of the beaker base 2 when the pressure inside is increased.

In addition, the beaker base 2 can have a predetermined breaking point and/or be designed as a burst pressure diaphragm.

From the illustrations according to the sequence shown in FIGS. 3a to 3d, it is technically understandable that the distances forming free spaces between adjacent crenellations in the beaker closure region are adapted to the electrical connection conditions of necessary busbars for the electrical secondary cell connection,

In this respect, the crenellation or crown structure is designed as a complementary element to a mechanical connecting means or clip 7, which is used to assemble a battery module.

An exemplary three-battery module is shown in FIGS. 3c and 3d.

The respective mechanical connecting means 7 can consist of an insulating material or have an electrically insulated section in order to create a guide for an electrical connection between the connection poles 9 by means of a respective conductive strip in the form of a busbar 8.

A large number of secondary cells, as shown in FIG. 4 for example, are joined into a sandwich structure after electrical contacting via the corresponding busbar connections 8 and mechanical coupling by the connecting means 7, by creating a mechanical connection to a base plate 9 and a cover plate 10. The result is a load-bearing sandwich structure. For example, the cover plate 10 can also merge into side walls to form a quasi-enclosing housing arrangement.

Within the sandwich structure, it is possible to arrange or integrate the electrical and other components required for a battery management system as well as for a thermal management system.

As can be understood from the descriptions of the exemplary embodiment, a basic principle of the present invention is to join individual accumulator cells as part of a sandwich structure to form a module. In this respect, the sandwich structure comprises a plurality of spacer elements whose main axis is parallel and whose extension in the axial direction is the same. The sandwich structure also has at least one base plate and one cover plate, the extension of which perpendicular to the main axis of the spacer elements is greater than the thickness of the plates and greater than the extension of the spacer elements, in this case the accumulator cell housings. Because the connection poles are set back and the crenellation or crown structure described above is present, the base and cover plates can be connected directly to the accumulator cell housing, resulting in a thermally optimized and load-bearing, fixed mechanical solution without subjecting the connection poles to unnecessary mechanical forces or loads.

The corresponding electrical connection pole is set back in relation to the maximum axial expansion of the cell housing and is protected within the crenellation or crown structure.

The free spaces between the crenellation or crown sections of the structure, i.e. the existing openings, are arranged in such a way that there is a symmetry that allows the cells to be arranged in a regular grid.

The aforementioned connecting elements lead to a deliberately spaced arrangement of the individual accumulator cell housings and a mechanical locking mechanism. The connecting elements can be designed in such a way that the walls of the cell housings touch each other or are spaced apart.

The connection to the respective base and cover plate is made via the upper sides or upper edges of the protrusions of the crenellation or crown structure, preferably by gluing, welding or comparable technologies.

Base and/or cover plates can be made of a coated metal, plastic, but in particular also of a carbon fiber-reinforced material or a combination of metallic materials with plastics.

1. Accumulator cell housing, consisting of a beaker-like structure with a beaker base (2), a beaker wall (1) and a beaker closure (3) opposite the beaker base (2), wherein the chemical-physical means required for storing electrical energy can be introduced into the beaker cavity, and with electrical connections (4; 5) at least in the region of the beaker closure, characterized in that, starting from the beaker base (2), a plurality of spaced protrusions (5) are formed distributed in the axial direction and circumferentially with respect to the beaker wall (1), which protrusions form a crenellation or crown structure,
furthermore a comparable crenellation or crown structure is present in the region of the beaker closure (3), wherein this is realized either by an extension of sections of the beaker wall (1) above the plane of the beaker closure (3) or by a plurality of spaced protrusions (6) which extend from the beaker closure (3) beyond an electrical connection pole (9) located there.

2. Accumulator cell housing according to claim 1, characterized in that the beaker base (2) is subject to deformation when the pressure in the sealed beaker-like structure increases, which deformation can be detected by a sensor arrangement.

3. Accumulator cell housing according to claim 2, characterized in that the beaker base (2) has a predetermined breaking point or is designed as a burst pressure diaphragm.

4. Accumulator cell housing according to claim 1, characterized in that the crenellation or crown structure on the beaker base side (2) and that in the region of the beaker closure (3) are of the same or different design and, in particular, the distances between two adjacent crenellations in the beaker closure (3) are adapted to the electrical connection conditions and necessary busbars (8) for the electrical secondary cell connection.

5. Accumulator cell housing according to claim 1, characterized in that the crenellation or crown structure is designed as a complementary element to a mechanical connecting means (7) in the construction of a battery module.

6. Accumulator cell housing according to claim 5, characterized in that the respective mechanical connecting means (7) consists of an insulating material or has an electrically insulated section and can be inserted on the beaker base side and/or the beaker closure side.

7. Accumulator cell housing according to claim 6, characterized in that a busbar connection (8) between adjacent electrical connections or connection poles (5) of secondary cells is routed via the respective mechanical connecting means (7).

8. Battery or battery module, consisting of a plurality of accumulator cell housings according to claim 1.

9. Battery or battery cell module according to claim 8, characterized in that the plurality of accumulator cell housings is arranged between a base plate (9) and a cover plate (10), forming a stable load-bearing sandwich structure.

10. Battery or battery module according to claim 9, characterized in that components necessary for a battery and/or thermal management system are integrated or structurally arranged in the sandwich composite.

11. Battery or battery module according to claim 9, characterized in that the crenellation or crown structure on the accumulator cell housings provides uniform to symmetrical heat dissipation and improved integration into a thermal management system.
